(19) United States
(12) Patent Application Publication
(10) Pub. No.: US 2026/0317584 A1
(43) Pub. Date: Oct. 15, 2026

(54) ADHESION PROMOTER FOR EDGE BANDS

(71) Applicant: KNEHO-LACKE GmbH, Horn-Bad Meinberg (DE)

(72) Inventors: Reinhard Hölscher, Horn-Bad Meinberg (DE); Eugen Lukanowski, Horn-Bad Meinberg (DE); Bernd Dinkelborg, Horn-Bad Meinberg (DE)

(21) Appl. No.: 19/648,092

(22) Filed: Apr. 15, 2026

(30) Foreign Application Priority Data
Apr. 15, 2025 (EP) 25170766.7

(51) Int. Cl. C09J 4/00; C09J 5/00; C09J 11/04; C09J 11/06; C09J 133/14

(52) U.S. Cl. CPC C09J 4/00; C09J 5/00; C09J 11/04; C09J 11/06; C09J 133/14

(57) ABSTRACT

The present invention relates to an adhesion promoter for edge bands, and a method for applying the adhesion promoter according to the invention to an edge band.

The present invention relates to an adhesion promoter for edge bands, and a method for applying the adhesion promoter according to the invention to an edge band.

Edge bands, also known as edge banding or edge strips, are used in the furniture industry to coat the narrow and end faces of material panels such as wood panels or wood-based panels, which are often designed as chipboard, fiberboard or composite panels. The attaching of the edge band is usually performed using conventional hot melt adhesives, but it can also be provided with a fused or functional layer during manufacturing, which is then melted during processing using suitable sources.

A corresponding edge band is described, for example, in DE 20 2016 101 048U, which relates to an edge band for coating workpieces, in particular for attachment to a curved surface of the workpiece, wherein the edge band has at least one base layer that is at least partially transparent and which consists at least partially of an elastomeric polymer mixture of at least one first copolymer based on acrylic and one second copolymer based on acrylic.

EP 0 562 166 discloses an edge band (edge banding) made of plastic, which optionally contains fillers and/or pigments, is printed and/or embossed, wherein the edge bands is cut from a paper-free plastic web of at least two layers or a continuous paper-free sheet of at least two layers with a material thickness of 400 μm to 4000 μm into strips of 12 mm to 200 mm, wherein the edge band has at least two layers produced by co-extrusion, multiple extrusion or lamination, and contains at least one layer or sheet that a) is at least one polyolefin layer or polyolefin sheet or polyolefin-containing layer or sheet and contains or consists of a propylene homo- and/or copolymer and/or high-density ethylene (HDPE), and b) contains at least one non-self-adhesive, solvent-free adhesive sheet or adhesion promoter layer arranged directly underneath or over one or more intermediate layers, which contains a polymer containing acid groups and/or ester groups and/or other polar groups.

In practice, edge bands often exhibit insufficient adhesion, which can lead to unwanted detachment over time. To increase the adhesion between the edge band and the workpiece, adhesion promoters can be used. These promote a stronger bond between the edge band and the material, or between the adhesives used for fastening. Although corresponding products, which are usually applied to the edge bands, are commercially available, these have the drawback of being mostly based on solvents, so that an energy-consuming drying procedure is necessary, before the edge band can be processed, and the production process stability during application is insufficient due to the evaporation of organic solvents/water during coating. In addition, solvent-based systems are generally problematic from an environmental perspective and are usually subject to regulatory requirements.

In view of the above, it is the object of the present invention to provide an adhesion promoter for fastening edge bands that overcomes the disadvantages of the prior art and ensures a permanent bond between the edge band and the workpiece while allowing for rapid further processing of the edge band.

Within the scope of the present invention, it has been surprisingly found that this object is achieved by a UV-curable adhesion promoter as defined in claim 1. Further aspects and preferred embodiments are set forth in the further independent and dependent claims.

Therefore, the present invention firstly relates to an adhesion promoter for edge bands comprising the following components:
a) from 50 to 90% by weight of at least one UV-curable component;
b) from 10 to 40% by weight of fillers; and
c) from 0.1 to 10% by weight of at least one photoinitiator.

Unless stated otherwise, the percentages by weight respectively relate to the total weight of the adhesion promoter.

In a preferred embodiment, the components of the adhesion promoter add up to 100% by weight.

The UV-curable component allows the adhesion promoter to be cured immediately after application, enabling a fully automated process and eliminating an energy- and time-consuming drying step. At the same time, the adhesion promoter according to the invention has proven compatible with common hot melt adhesives, resulting in a stable bond between the edge band and the workpiece.

In a preferred embodiment, the proportion of said at least one UV-curable component in the adhesion promoter is from 60 to 80% by weight, more preferably from 65 to 75% by weight, respectively based on the total weight of the adhesion promoter. With proportions of at least one UV-curable component in the specified ranges, sufficiently rapid curing of the adhesion promoter could be achieved in the automated process, while at the same time sufficient processing time was maintained.

The adhesion promoter according to the invention is characterized by the fact that it hardens under the influence of UV radiation, and that the edge band can be further processed immediately. At the same time, the adhesion promoter according to the invention supports the formation of a strong bond between the edge band and the workpiece. To achieve this combination of properties, embodiments of the present invention have proven preferable in which the at least one UV-curable component is selected from the group of acrylates and polyurethanes. More preferred are polyester and amine acrylates, and among those especially the cyclic and aliphatic ones. Therefore, an embodiment of the present invention is preferred in which said at least one UV-curable component is selected from the group consisting of cyclic and aliphatic acrylates, in particular cyclic and/or aliphatic polyester and amine acrylates.

The purpose of the adhesion promoter according to the invention is, among other things, to form a structured surface in order to further increase the adhesion between the edge band and the workpiece. Within the scope of the present invention, this is achieved by the adhesion promoter according to the invention containing fillers. In this context, an embodiment is preferred in which the proportion of fillers in the adhesion promoter is from 12 to 35% by weight, more preferably from 15 to 25% by weight, respectively based on the total weight of the adhesion promoter. The proportion of fillers in the specified ranges enabled the creation of a surface structure that supports adhesion without being so rough as to no longer provide a basis for adhesion.

To achieve the desired surface structuring, the fillers are preferably amorphous silicon dioxides, in particular pyrogenic and precipitated silicas, as well as mixtures thereof. Within the scope of the present invention, both posttreated and non-posttreated silicas with a particle size of 2-15 μm can be used. The particle size can be determined, for example, by laser diffraction.

The adhesion promoter according to the invention further comprises at least one photoinitiator which, under the influence of UV radiation, initiates the polymerization of the at least one UV-curable component. In a preferred embodiment, the amount of photoinitiator in the adhesion promoter according to the invention is from 1 to 10% by weight, more preferably from 2 to 7% by weight, respectively based on the total weight of the adhesion promoter. The amount of photoinitiator can be adjusted as needed, but should be within the specified ranges to avoid the adhesion promoter curing too quickly or too slowly.

The photoinitiator can be matched to the UV-curable component of the adhesion promoter and is preferably selected from the group of α-hydroxyketones and thioxanthones. A mixture of two or more photoinitiators can also be used.

The mechanical and rheological properties of the adhesion promoter according to the invention can be adapted as required. For this purpose, the adhesion promoter according to the invention can further comprise up to 10 wt. %, preferably up to 5 wt. %, of additives, respectively based on the total weight of the adhesion promoter. The additives are preferably selected from the group consisting of bentonites, silanes, siloxanes and acrylates, as well as mixtures thereof. Silanes with reactive glycidyl and methoxy groups are preferred. Polysiloxanes and polyethersiloxane copolymers have proven advantageous as further additives, particularly for additionally improving adhesion. The components additionally present as additives in the adhesion promoter differ from those present as components a) to c) in the adhesion promoter according to the invention.

Conventional adhesion promoters are mostly water- or solvent-based, which has the disadvantage that, firstly, energy- and time-intensive drying is required before the edge band can be processed further, and secondly, the solvent evaporates during application, so that a stable application quantity cannot be achieved. Within the scope of the present invention, it has been surprisingly found that the adhesion promoter according to the invention requires only a small amount of solvent, such as organic solvents or water, thus ensuring a guaranteed application quantity and high product stability. The impurities that normally occur when applying conventional adhesion promoters can also be avoided by using the adhesion promoter according to the invention, so that no cleaning effort is required and the adhesion promoter can be applied in a fully automated process with low waste. In a preferred embodiment, the proportion of solvent in the adhesion promoter according to the invention is less than 5% by weight, preferably less than 2% by weight, respectively based on the total weight of the adhesion promoter. The small amount of solvent in the adhesion promoter according to the invention makes an important contribution to the environmental compatibility and sustainability of the product, in addition to the process-related advantages.

The adhesion promoter according to the invention is designed to be applied to an edge band. Therefore, the present invention further relates to a method for applying the adhesion promoter according to the invention to an edge band, in which the adhesion promoter is applied to an edge band using a rolling process, and then irradiated with UV radiation. Advantageously, the application and irradiation can be combined. Preferably, a UV source with an emission spectrum of 200 to 420 nm is used for irradiation, whereby the number of UV sources can be adjusted depending on the process parameters.

Within the scope of the method according to the invention, it has surprisingly been found that the amount of adhesion promoter required can be reduced by using the adhesion promoter according to the invention without impairing the bond strength between the edge band and the workpiece. Therefore, an embodiment is preferred in which the adhesion promoter is applied in an amount of 6 to 20 g/m², preferably 10 to 15 g/m².

The adhesion promoter according to the invention causes the applied adhesion promoter to cure quickly, which in turn means that the roller feed can be increased, thus allowing more product to be manufactured in the same amount of time. Therefore, an embodiment in which the roller feed is 2 to 40 m/min is preferred.

Within the scope of the method according to the invention, the usual edge bands can be employed. Preferably, the edge band material is plastic, in particular one selected from the group consisting of acrylonitrile/butadiene/styrene (ABS) copolymer, polypropylene (PP) and polyvinyl chloride (PVC).

The adhesion promoter and the method according to the invention enable a fast and efficient application of the adhesion promoter to an edge band and the formation of a stable bond between the edge band and the workpiece, as illustrated by the following Examples, which are by no means to be understood as a limitation of the inventive concept.

Table 1 shows an exemplary composition of an adhesion promoter according to the invention, which was tested in the context of the following Examples, with the values given in weight %.

TABLE 1

| | Proportion |
|---|---|
| Ingredient | [%] |
| Acrylated oligoamine | 10.0 |
| Acrylated polyester | 5.0 |
| Cyclic aliphatic monoacrylate I | 5.0 |
| Cyclic aliphatic monoacrylate II | 51.0 |
| Anti-settling agent | 1.0 |
| Dispersant | 4.0 |
| Defoamer | 0.2 |
| Photoinitiator I | 0.5 |
| Photoinitiator II | 4.0 |
| Hydrophilic pyrogenic silica | 3.0 |
| Untreated precipitated silica | 14.8 |
| Silane-functional adhesion promoter | 1.0 |
| Wetting and leveling agents | 0.5 |
| Total | 100.0 |

For comparison purposes, the same tests were carried out using a conventional adhesion promoter:
Comparison: JOWAT Primer 406.09, solvent-based

The adhesion promoter according to the invention was applied to an edge band and cured under the specified conditions, and the edge band was then fixed to the workpiece.
Speed: 10-20 m/min
UV-A: 170-300 mJ/cm²/200-350 mW/cm²
UV-B: 170-280 mJ/cm²/215-360 mW/cm²
UV-C: 70-115 mJ/cm²/80-130 mW/cm²
UV-V: 160-270 mJ/cm²/195-325 mW/cm²

The conventional adhesion promoter was processed and applied as specified in the instructions for use. The drying time of the adhesion promoter was awaited, and the edge band was fixed to the workpiece.

The edge band was then removed in a peel-off test, and the force required for removal was determined. The required force should be at least 70 N.

### EXAMPLE 1

Substrate: Chipboard 19 mm
Comparative adhesion promoter 1: 72 N
Adhesion promoter according to the invention 74 N

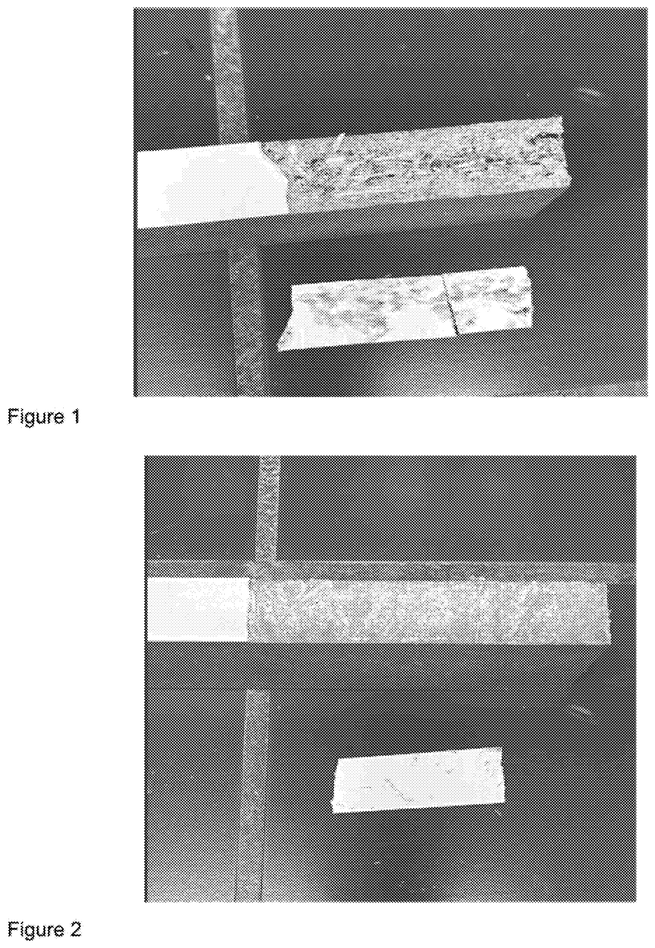

FIG. 1 shows the result of the peel-off test relating to the adhesion promoter according to the invention. The observed type of fracture in the material shows that the cohesive strength in the edge band is lower than the bond between the adhesion promoter and the adhesive used to apply the edge band.

### EXAMPLE 2

Substrate: On MDF 19 mm
Comparative adhesion promoter 1: 71 N
Adhesion promoter according to the invention 75 N

FIG. 2 shows the result of the peel-off test for the adhesion promoter according to the invention. At a peel force of 75 N, the edge band material fractured, which shows that the cohesive strength of the edge band is lower than the bond between the edge band and the adhesive used to apply the edge band.

As the Examples show, the adhesion promoter according to the invention fulfills all the requirements for the fastening of edge bands and, in addition, surpasses the results achieved with conventional adhesion promoters. Furthermore, the adhesion promoter according to the invention offers the advantage that no drying time is required, and the workpiece can be processed further immediately.

It is claimed:

1. An adhesion promoter for edge bands, characterized in that the adhesion promoter comprises:
a) from 50 to 90% by weight of at least one UV-curable component,
b) from 10 to 40% by weight of fillers,
c) from 0.1 to 10% by weight of at least one photoinitiator,
the percentages by weight being respectively based on the total weight of the adhesion promoter.

2. The adhesion promoter according to claim 1, characterized in that a proportion of said at least one UV-curable component in the adhesion promoter is from 60 to 80% by weight, based on the total weight of the adhesion promoter.

3. The adhesion promoter according to claim 1, characterized in that said at least one UV-curable component is selected from the group consisting of acrylates and polyurethanes.

4. The adhesion promoter according to claim 3, characterized in that said at least one UV-curable component is selected from the group consisting of polyester and amine acrylates.

5. The adhesion promoter according to claim 1, characterized in that a proportion of fillers in the adhesion promoter is from 12 to 35% by weight, based on the total weight of the adhesion promoter.

6. The adhesion promoter according to claim 1, characterized in that the fillers are selected from the group consisting of amorphous silicas, consisting of pyrogenic and precipitated silicas, with or without aftertreatment, as well as mixtures thereof.

7. The adhesion promoter according to claim 1, characterized in that the adhesion promoter comprises from 1 to 10% by weight, preferably from 2 to 7% by weight, of said at least one photoinitiator, respectively based on the total weight of the adhesion promoter.

8. The adhesion promoter according to claim 1, characterized in that said photoinitiator is selected from the group consisting of α-hydroxyketones and thioxanthones.

9. The adhesion promoter according to claim 1, characterized in that the adhesion promoter further comprises up to 10% by weight, preferably up to 5% by weight, of additives, respectively based on the total weight of the adhesion promoter.

10. The adhesion promoter according to claim 9, characterized in that said additives are selected from the group consisting of bentonites, silanes, siloxanes, and acrylates.

11. A process for applying an adhesion promoter applying the adhesion promoter to an edge band using a rolling process, and then irradiating the adhesion promoter with UV radiation;
wherein the adhesion promoter comprises:
a) from 50 to 90% by weight of at least one UV-curable component,
b) from 10 to 40% by weight of fillers,
c) from 0.1 to 10% by weight of at least one photoinitiator,
the percentages by weight being respectively based on the total weight of the adhesion promoter.

12. The process according to claim 11, characterized in that the adhesion promoter is applied at a coverage of from 6 to 20 g/m².

13. The process according to claim 11, characterized in that a feed rate of the roller is from 2 to 40 m/min.

14. The process according to claim 11, characterized in that a material of the edge band is selected from the group consisting of acrylonitrile/butadiene/styrene (ABS) copolymer, polypropylene (PP), and polyvinyl chloride (PVC).

15. The process according to claim 11, characterized in that the adhesion promoter is applied at a coverage of from 10 to 15 g/m.

16. The process according to claim 12, characterized in that a feed rate of the roller is from 2 to 40 m/min.

17. The process according to claim 13, characterized in that a material of the edge band is selected from the group consisting of acrylonitrile/butadiene/styrene (ABS) copolymer, polypropylene (PP), and polyvinyl chloride (PVC).

18. The adhesion promoter according to claim 1, characterized in that the proportion of said at least one UV-curable component in the adhesion promoter is from 65 to 75% by weight based on the total weight of the adhesion promoter.

19. The adhesion promoter according to claim 3, characterized in that said at least one UV-curable component is selected from the group consisting of cyclic and aliphatic polyester and amine acrylates.

20. The adhesion promoter according to claim 1, characterized in that a proportion of fillers in the adhesion promoter is from 15 to 25% by weight based on the total weight of the adhesion promoter.
